(19) United States
(12) Patent Application Publication
(10) Pub. No.: US 2012/0162420 A1
(43) Pub. Date: Jun. 28, 2012

(54) VEHICLE-MOUNTED CAMERA

(75) Inventor: Hiroaki ONISHI, Kyoto (JP)

(73) Assignee: ROHM CO., LTD., Kyoto (JP)

(21) Appl. No.: 13/332,724

(22) Filed: Dec. 21, 2011

(30) Foreign Application Priority Data
Dec. 22, 2010 (JP) 2010-285691

(51) Int. Cl. H04N 7/18

(52) U.S. Cl. 348/143; 348/E07.085

(57) ABSTRACT

A vehicle-mounted camera includes an imaging device, and a light-transmitting window and a reflection device adjoining to each other in a first direction. The imaging device is configured to assume a first posture in which the light-transmitting window occupies a greater proportion of an imaging range of the imaging device than the reflection device and a second posture in which the reflection device occupies a greater proportion of the imaging range than in the first posture.

### CROSS-REFERENCE TO RELATED APPLICATION

This application is based upon and claims the benefit of priority from Japanese Patent Application No. 2010-285691, filed on Dec. 22, 2010, the entire contents of which are incorporated herein by reference.

### TECHNICAL FIELD

The present disclosure relates to a vehicle-mounted camera mounted on a motor vehicle such as a passenger car or the like.

### BACKGROUND

A vehicle-mounted camera employing a camera unit installed on a motor vehicle is extensively used to record the travel conditions of the motor vehicle or to provide the driver with assistance during the travel of the motor vehicle. A vehicle-mounted camera 90 shown in FIG. 17 is used as a so-called drive recorder (see, e.g., Japanese Patent Application Laid-Open No. 2000-6854 A). The vehicle-mounted camera 90 is attached to, e.g., a windshield 92 or a rearview mirror of a motor vehicle 91 to take an image of a vehicle front view, i.e., the view in front of the motor vehicle. The image taken by the vehicle-mounted camera 90 is recorded at all times or for a specified time, e.g., for a time period starting from a few seconds or a few minutes until the time point at which an accident occurs.

However, there is an increasing demand for the vehicle-mounted camera 90 (used as a drive recorder) to take an image of an inside of the motor vehicle 91 as well as the image of the front view of the motor vehicle 91. The function of recording an image of the inside of the motor vehicle 91 is desirable, e.g., for detecting when an unlawful action is exercised by a passenger within a taxi. In order to meet such a demand, another vehicle-mounted camera is required for taking an image of the inside of the motor vehicle 91 in addition to the vehicle-mounted camera 90 for taking an image of the front view of the motor vehicle 91.

### SUMMARY

The present disclosure provides some embodiments of a vehicle-mounted camera capable of widely and clearly taking an image of a certain region and capable of simultaneously taking images of a plurality of different regions.

According to one embodiment of the present disclosure, there is provided a vehicle-mounted camera, including an imaging device having a predetermined imaging range; and a light-transmitting window and a reflection device adjoining to each other in a first direction, the imaging device configured to selectively assume one of a first posture, in which the light-transmitting window occupies a greater proportion of the imaging range than the reflection device, and a second posture, in which the reflection device occupies a greater proportion of the imaging region than in the first posture.

In another embodiment of the present disclosure, the camera may further include a case in which the light-transmitting window and the reflection device are arranged, the case configured to rotatably support the imaging device in a second direction perpendicular to the first direction.

In yet another embodiment of the present disclosure, the case may include a rear plate portion positioned at a rear side of the imaging device and a top plate portion positioned at one side of the imaging device in the first direction.

In still another embodiment of the present disclosure, the camera may further include a transparent plate attached to a front end of the top plate portion to face the imaging device; the reflection device including a mirror arranged on a first portion of the transparent plate at the other side of the imaging device in the first direction, and the light-transmitting window is formed in a second portion of the transparent plate.

In still another embodiment of the present disclosure, at least the second portion of the transparent plate in which the light-transmitting window is formed may be applied with an anti-reflection coating.

In still another embodiment of the present disclosure, the transparent plate may have an elbow formed in a boundary between the light-transmitting window and the mirror.

In still another embodiment of the present disclosure, the camera may further include an auxiliary transparent plate attached to an end of the transparent plate at the other side of the imaging device in the first direction, the auxiliary transparent plate configured to extend toward the one side of the imaging device in the first direction and to terminate at the rear side of the imaging device.

In still another embodiment of the present disclosure, the rear plate portion may have an opening, the imaging device including a rotation lever protruding outward through the opening.

In still another embodiment of the present disclosure, the light-transmitting window may have an elongated rectangular shape extending in the second direction.

In still another embodiment of the present disclosure, the reflection device may have an elongated rectangular shape extending in the second direction.

In still another embodiment of the present disclosure, the camera may further include a bracket configured to rotatably support the case in the second direction.

In still another embodiment of the present disclosure, the bracket may include an installation plate extending in the second direction and a pair of support plates extending from opposite ends in the second direction of the installation plate toward opposite ends in the second direction of the case, the case rotatably connected to the support plates.

In still another embodiment of the present disclosure, the bracket may be attached to an inner surface of a windshield or a rearview mirror of a motor vehicle, and the light-transmitting window positioned above the reflection device.

In still another embodiment of the present disclosure, the light-transmitting window and the reflection device may be positioned in front of the imaging device in a travel direction of the motor vehicle. A front region of the motor vehicle may be captured by the imaging device in the imaging range through the light-transmitting window, when the imaging device is in the first posture, while the front region of the motor vehicle may be captured by the imaging device in the imaging range through the light-transmitting window with at least one of an inside of the motor vehicle and a rear region of the motor vehicle captured in an area of the imaging range occupied by the reflection device, when the imaging device is in the second posture.

In still another embodiment of the present disclosure, the light-transmitting window and the reflection device may be positioned behind the imaging device in a travel direction of the motor vehicle. At least one of an inside of the motor vehicle and a rear region of the motor vehicle may be captured by the imaging device in the imaging range through the light-transmitting window, when the imaging device is in the first posture, while at least one of the inside of the motor vehicle and the rear region of the motor vehicle may be captured by the imaging device in the imaging range through the light-transmitting window with a front region of the motor vehicle captured in an area of the imaging range occupied by the reflection device, when the imaging device is in the second posture.

In still another embodiment of the present disclosure, the bracket may be attached to an upper surface of a dashboard of a motor vehicle, and the light-transmitting window positioned above the reflection device.

In still another embodiment of the present disclosure, the light-transmitting window and the reflection device may be positioned in front of the imaging device in a travel direction of the motor vehicle. A front region of the motor vehicle may be captured by the imaging device in the imaging range through the light-transmitting window, when the imaging device is in the first posture, while the front region of the motor vehicle may be captured by the imaging device in the imaging range through the light-transmitting window with at least one of an inside of the motor vehicle and a rear region of the motor vehicle captured in an area of the imaging range occupied by the reflection device, when the imaging device is in the second posture.

In still another embodiment of the present disclosure, the light-transmitting window and the reflection device may be positioned behind the imaging device in a travel direction of the motor vehicle. At least one of an inside of the motor vehicle and a rear region of the motor vehicle may be captured by the imaging device in the imaging range through the light-transmitting window, when the imaging device is in the first posture, while at least one of the inside of the motor vehicle and the rear region of the motor vehicle may be captured by the imaging device in the imaging range through the light-transmitting window with a front region of the motor vehicle captured in an area of the imaging range occupied by the reflection device, when the imaging device is in the second posture.

In still another embodiment of the present disclosure, the bracket may be attached to an upper surface of a dashboard of a motor vehicle, and the light-transmitting window positioned below the reflection device.

In still another embodiment of the present disclosure, the light-transmitting window and the reflection device may be positioned in front of the imaging device in a travel direction of the motor vehicle. A front region of the motor vehicle may be captured by the imaging device in the imaging range through the light-transmitting window, when the imaging device is in the first posture, while the front region of the motor vehicle may be captured by the imaging device in the imaging range through the light-transmitting window with at least one of an inside of the motor vehicle and a rear region of the motor vehicle captured in an area of the imaging range occupied by the reflection device, when the imaging device is in the second posture.

In still another embodiment of the present disclosure, the light-transmitting window and the reflection device may be positioned behind the imaging device in a travel direction of the motor vehicle. At least one of an inside of the motor vehicle and a rear region of the motor vehicle may be captured by the imaging device in the imaging range through the light-transmitting window, when the imaging device is in the first posture, while at least one of the inside of the motor vehicle and the rear region of the motor vehicle may be captured by the imaging device in the imaging range through the light-transmitting window with a front region of the motor vehicle captured in an area of the imaging range occupied by the reflection device, when the imaging device is in the second posture.

Other features and advantages of the present disclosure will become apparent from the following detailed description made with reference to the accompanying drawings.

### BRIEF DESCRIPTION OF THE DRAWINGS

FIG. 1 is a perspective view showing a vehicle-mounted camera according to a first embodiment of the present disclosure.

FIG. 2 is a section view taken along line II-II in FIG. 1, in which the vehicle-mounted camera assumes a first posture.

FIG. 3 is a side view illustrating the view field of the vehicle-mounted camera shown in FIG. 2.

FIG. 4 is a section view taken along line II-II in FIG. 1, in which the vehicle-mounted camera assumes a second posture.

FIG. 5 is a side view illustrating the view fields of the vehicle-mounted camera shown in FIG. 4.

FIG. 6 is a section view showing a vehicle-mounted camera according to a second embodiment of the present disclosure, in which the vehicle-mounted camera assumes a first posture.

FIG. 7 is a section view showing the vehicle-mounted camera according to the second embodiment of the present disclosure, in which the vehicle-mounted camera assumes a second posture.

FIG. 8 is a section view showing a vehicle-mounted camera according to a third embodiment of the present disclosure, in which the vehicle-mounted camera assumes a first posture.

FIG. 9 is a section view showing the vehicle-mounted camera according to the third embodiment of the present disclosure, in which the vehicle-mounted camera assumes a second posture.

FIG. 10 is a side view illustrating the view fields of the vehicle-mounted camera shown in FIG. 9.

FIG. 11 is a section view showing a vehicle-mounted camera according to a fourth embodiment of the present disclosure, in which the vehicle-mounted camera assumes a first posture.

FIG. 12 is a section view showing the vehicle-mounted camera according to the fourth embodiment of the present disclosure, in which the vehicle-mounted camera assumes a second posture.

FIG. 13 is a section view showing a vehicle-mounted camera according to a fifth embodiment of the present disclosure, in which the vehicle-mounted camera assumes a first posture.

FIG. 14 is a section view showing the vehicle-mounted camera according to the fifth embodiment of the present disclosure, in which the vehicle-mounted camera assumes a second posture.

FIG. 15 is a section view showing a vehicle-mounted camera according to a sixth embodiment of the present disclosure, in which the vehicle-mounted camera assumes a first posture.

FIG. 16 is a section view showing the vehicle-mounted camera according to the sixth embodiment of the present disclosure, in which the vehicle-mounted camera assumes a second posture.

FIG. 17 is a side view showing one example of a conventional vehicle-mounted camera.

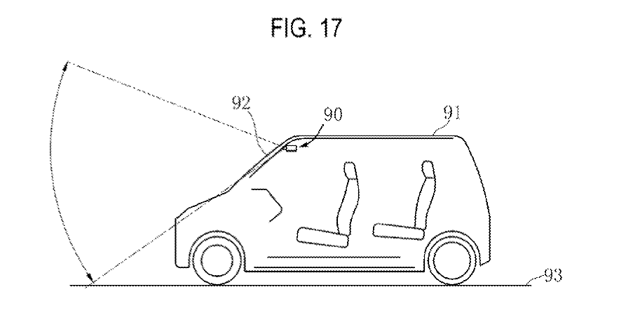

### DETAILED DESCRIPTION

Certain preferred embodiments of the present disclosure will now be described in detail with reference to the drawings.

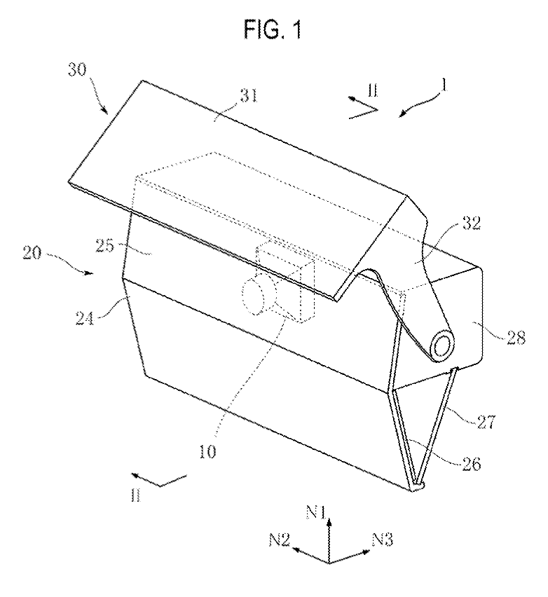

FIGS. 1 through 5 show a vehicle-mounted camera according to a first embodiment of the present disclosure. The vehicle-mounted camera I of the present embodiment includes a camera unit 10, a case 20 and a bracket 30. The vehicle-mounted camera 1 is configured to serve as a so-called drive recorder and is capable of appropriately recording a situation of a front side Fr in a vehicle moving direction, an in-vehicle situation and a situation of a back side Bk in the vehicle moving direction.

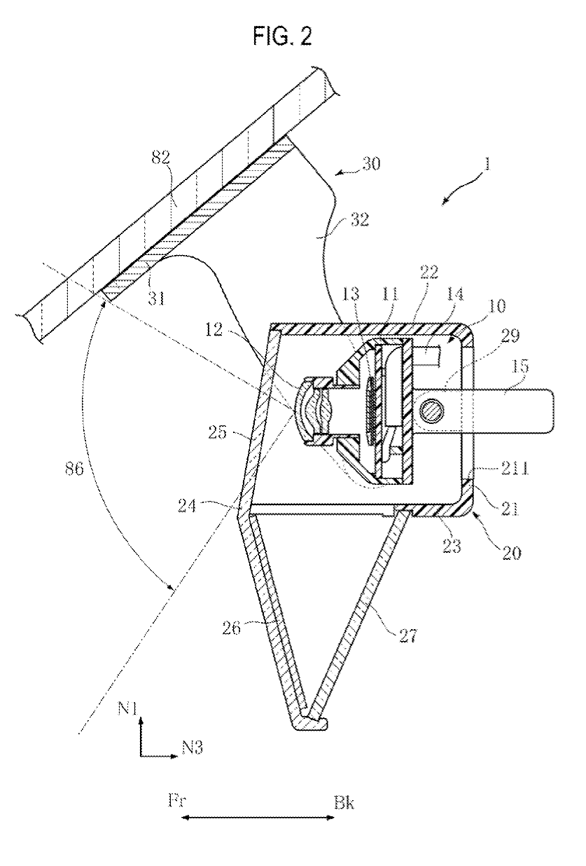

The camera unit 10 is provided as one example of an imaging device as referred to herein. As shown in FIG. 2, the camera unit 10 includes a casing 11, a lens unit 12 and an imaging element 13. The casing 11 accommodates the lens unit 12 and the imaging element 13. The casing 11 is made of, e.g., black plastic. The lens unit 12 is formed of a plurality of superimposed lenses and is configured to focus the light coming from a relatively wide view field on the imaging element 13. The imaging element 13 is formed of, e.g., a CCD element, and has a photoelectric conversion function by which the light incident on a light receiving surface (not shown) is converted into electricity. Imaging signals are transmitted from the imaging element 13 to an image recording device or a monitor (not shown) through, e.g., a cable 14. A rotation lever 15 is formed in the casing 11. Specifically, the rotation lever 15 protrudes from the casing 11 at the rear surface side of the camera unit 10.

The case 20 accommodates the camera unit 10 and includes a back plate 21, a top plate 22, a bottom plate 23, two side plates 28, a transparent plate 24, a mirror 26, an auxiliary transparent plate 27, and two support brackets 29. The back plate 21, the top plate 22, the bottom plate 23 and the two side plates 28 are configured to form a basis of the case 20 and are made of, e.g., a resin or a metal plate. The back plate 21, the top plate 22 and the bottom plate 23 have an elongated rectangular shape extending in a longitudinal direction thereof, i.e., in a direction N2. The top plate 22 and the bottom plate 23 are spaced apart from each other in a direction N1 and are parallel to each other. In the present embodiment, the dimension of the bottom plate 23 in a direction N3 is set to be significantly smaller than the dimension of the top plate 22 in the direction N3. The back plate 21 interconnects the top plate 22 and the bottom plate 23. The back plate 21 is arranged at a right angle with respect to the direction N3. The two support brackets 29 protrude inward from the back plate 21. The two support brackets 29 are parallel to each other and are spaced apart from each other in the direction N2. The two support brackets 29 support the camera unit 10 to rotate about an axis extending in the direction N2. An opening 211 is formed in the back plate 21. The rotation lever 15 of the camera unit 10 is exposed at the rear surface side through the opening 211. The two side plates 28 are attached to opposite ends of the back plate 21 in the direction N2 and are also attached to the top plate 22 and the bottom plate 23.

The transparent plate 24 is made of transparent material, e.g., acryl resin. The transparent plate 24 is attached to a front end of the top plate 22 in the direction N1 and has an elongated rectangular shape extending in a longitudinal direction thereof, i.e., in the direction N2. The transparent plate 24 has an elbow substantially at a midpoint thereof in the direction N1. The portion of the transparent plate 24 extending from the elbow toward the top plate 22 in the direction N1 is arranged to face the front side of the camera unit 10. This portion is formed of a light-transmitting window 25. The mirror 26 is attached to the portion of the transparent plate 24 extending from the elbow away from the top plate 22 in the direction N1. The mirror 26 may be a typical mirror or a metal film finished with a mirror surface. The mirror 26 is one example of a reflection device as referred to herein. The auxiliary transparent plate 27 is made of transparent material, e.g., acryl resin. The auxiliary transparent plate 27 is attached to an end portion of the transparent plate 24 at one end of the auxiliary transparent plate 27 opposite to the top plate 22 in the direction N1 and attached to a front end of the bottom plate 23 at the other end of the auxiliary transparent plate 27 in the direction N3. An anti-reflection coating such as an AR coat or the like may be applied on the transparent plate 24 and the auxiliary transparent plate 27. In order to address the problem that the front view seen through the light-transmitting window 25 contains an extremely large amount of light, the transparent plate 24 may be subjected to light reduction treatment for reducing the light transmission rate. Examples of the light reduction treatment include providing a light reduction filter or a photochromic-containing filter. The light reduction filter is a resin film having a light transmission rate of about 50%. The photochromic-containing filter is a filter whose light transmission rate is momentarily reduced upon receiving light with a specific wavelength such as ultraviolet light. These filters may be provided either inside or outside of the transparent plate 24. Moreover, an image may be subjected to AIE (adaptive image enhancer) processing through the use of an image processing LSI (not shown) provided in the camera unit 10, thereby reducing underexposure or overexposure. In the AIE processing, the image is divided into a plurality of sections and each of the sections is subjected to level correction.

The bracket 30 is used to support the case 20 and to fix the vehicle-mounted camera 1 to an installation object. The bracket 30 includes an installation plate 31 and two support plates 32. The bracket 30 is formed of, e.g., a metal plate. The installation plate 31 has an elongate rectangular shape extending in a longitudinal direction thereof, i.e., in the direction N2. The installation plate 31 is fixed to the installation object by a suction pad or bolts (not shown). The two support plates 32 extend from two opposite ends of the installation plate 31 in the direction N2 at a right angle with respect to the installation plate 31. End portions of the two support plates 32 are attached to the two side plates 28 of the case 20 so that the case 20 can rotate with respect to the bracket 30 about an axis extending in the direction N2.

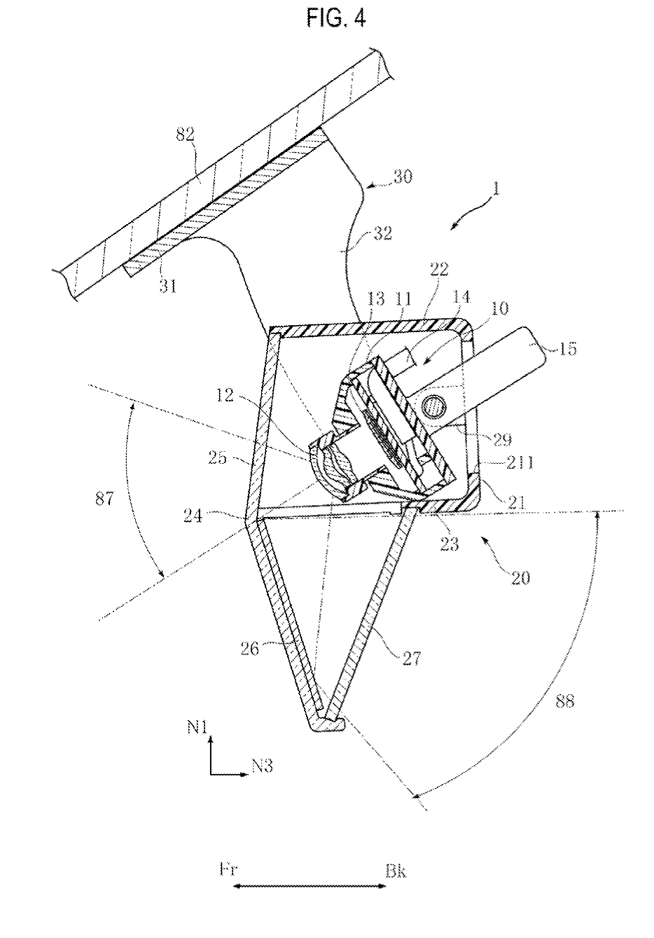

FIGS. 2 and 4 show the vehicle-mounted camera 1 attached to the inner surface of a windshield 82. In the attachment states shown in FIGS. 2 and 4, the direction NI of the vehicle-mounted camera 1 substantially coincides with a vertical direction, and the direction N3 substantially coincides with a front side Fr to back side Bk direction of a motor vehicle 81. Even if the vehicle-mounted camera 1 is attached to a rearview mirror (not shown) of the motor vehicle 81 in place of the windshield 82, the same state as shown in FIGS. 2 and 4 can be obtained.

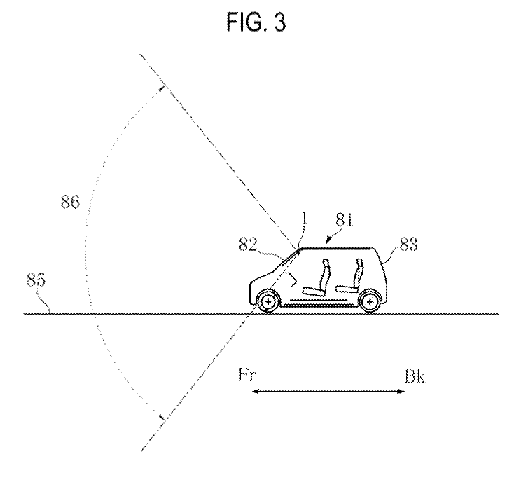

The vehicle-mounted camera I shown in FIG. 2 assumes a “first posture” as referred to herein. In the first posture, an imaging range of the camera unit 10 is almost completely occupied by the light-transmitting window 25. Accordingly, the camera unit 10 takes an image of the front region of the motor vehicle 81 shown in FIG. 3 through the light-transmitting window 25 and the windshield 82. More specifically, a road 85 extending toward the front side Fr of the motor vehicle 81 and cars and pedestrians existing on the road 85 are included in the front region. The angle of view 86 is, e.g., about 103°.

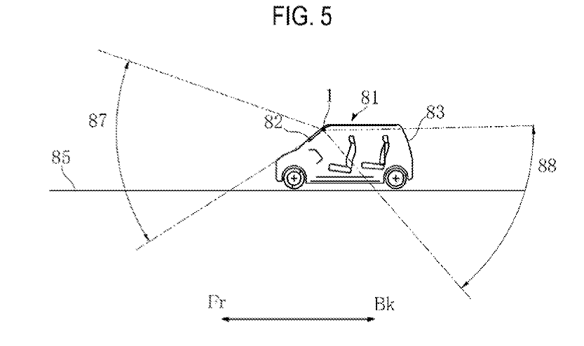

The vehicle-mounted camera I shown in FIG. 4 assumes a “second posture” as referred to herein. In order to change the first posture to the second posture, the rotation lever 15 is operated to rotate the camera unit 10 with respect to the case 20 about the axis extending in the direction N2. In the second posture, an upper area of the imaging range of the camera unit 10 is occupied by the light-transmitting window 25 while a lower area of the imaging range is occupied by the mirror 26. Therefore, the front region of the motor vehicle 81 shown in FIG. 3 is captured in the upper area of the image taken by the camera unit 10 through the light-transmitting window 25 and the windshield 82. The in-vehicle situation seen through the auxiliary transparent plate 27 and the rear region of the motor vehicle 81 seen through a rear window 83 as illustrated in FIG. 5 are reflected by the mirror 26 and captured in the lower area of the image taken by the camera unit 10. More specifically, the road 85 extending toward the back side Bk of the motor vehicle 81 and cars and pedestrians existing on the road 85 are included in the rear region. The angle of view 87 is, e.g., about 52° and the angle of view 88 is, e.g., about 50°.

The following is a description of operations of the vehicle-mounted camera 1.

In the present embodiment, when the vehicle-mounted camera 1 is in the first posture shown in FIG. 2, it is possible to capture the front region of the motor vehicle 81 in the substantially full area of the image taken by the camera unit 10. This makes it possible to clearly record, e.g., the situation of the front region while driving. On the other hand, when the vehicle-mounted camera 1 is in the second posture shown in FIG. 4, it is possible to simultaneously record the front region of the motor vehicle 81, the in-vehicle situation, and the rear region of the motor vehicle 81 in the image taken by the camera unit 10.

The first posture and the second posture can be easily inter-switched by operating the rotation lever 15. Accordingly, the first posture and the second posture may be suitably selected depending on a driving place and the existence or absence of a fellow passenger.

By attaching the mirror 26 to the transparent plate 24 of a curved or bent shape, the rear view of the camera unit 10 can be appropriately included in the image through the reflection on the mirror 26. Additionally, the auxiliary transparent plate 27 assists in increasing the rigidity of the case 20 without hindering the imaging operation through the reflection on the mirror 26. If an anti-reflection coating such as an AR coat or the like is applied on the transparent plate 24 and the auxiliary transparent plate 27, it is possible to prevent an undesired object from being captured in the image of the camera unit 10.

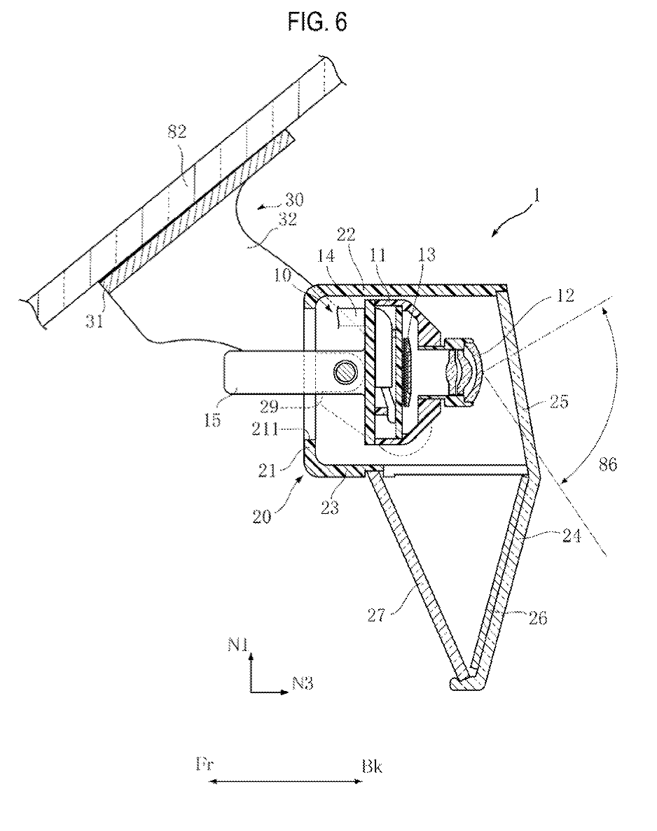

FIGS. 6 through 16 show other embodiments of the present disclosure. In FIGS. 6 through 16, the components identical or similar to those of the foregoing embodiment will be designated by like reference symbols. The embodiments shown in FIGS. 6 through 16 can be implemented by setting an installation position and installation direction of the vehicle-mounted camera 1 as described in the first embodiment and adapting the relative angle of the case 20 and the bracket 30 to the structures described in the respective embodiments.

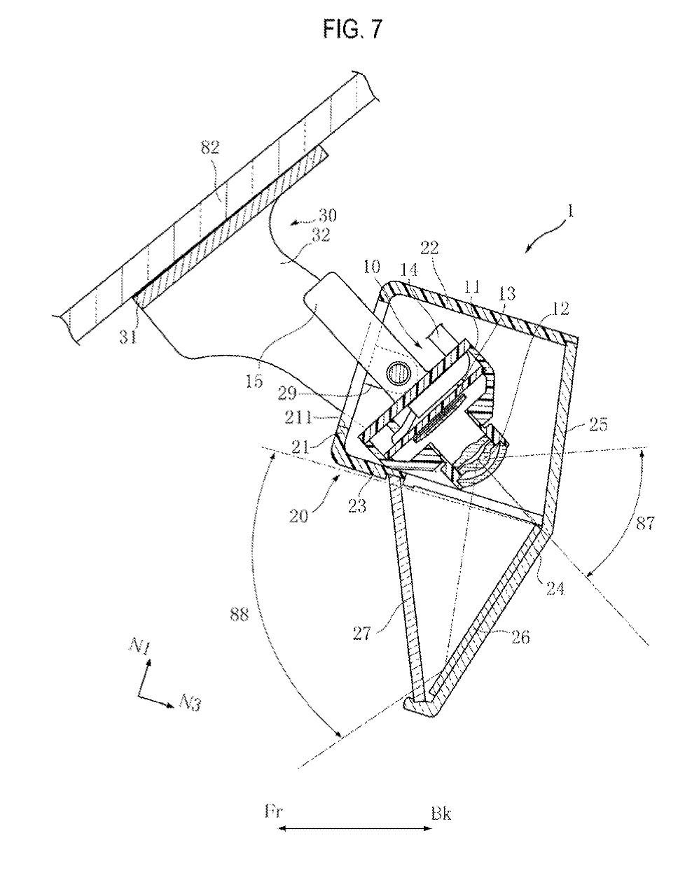

FIGS. 6 and 7 show a vehicle-mounted camera according to a second embodiment of the present disclosure. The vehicle-mounted camera 1 of the present embodiment differs from the camera of the first embodiment in that a front surface of the camera unit 10 faces toward the back side Bk. FIG. 6 illustrates the vehicle-mounted camera 1 of the present embodiment assuming a first posture. In this state, the in-vehicle situation and the rear region of the motor vehicle 81 are captured in the image taken by the camera unit 10. FIG. 7 illustrates the vehicle-mounted camera 1 of the present embodiment assuming a second posture. In this state, the in-vehicle situation and the rear region of the motor vehicle 81 are captured in the upper area of the image taken by the camera unit 10 while the front region of the motor vehicle 81 is captured in the lower area of the image taken by the camera unit 10.

If the image from the camera unit 10 of the present embodiment is displayed on a monitor installed in, e.g., a dashboard of the motor vehicle 81, a left-right direction of a driver's sight is inversely captured in the image, i.e., displayed in the left-right direction of the image. It is therefore preferable to invert the image supplied from the camera unit 10 and then display an inverted image on the monitor.

In the present embodiment, it is possible for the camera unit 10 to widely and clearly take an image of a certain region and simultaneously take images of a plurality of different regions.

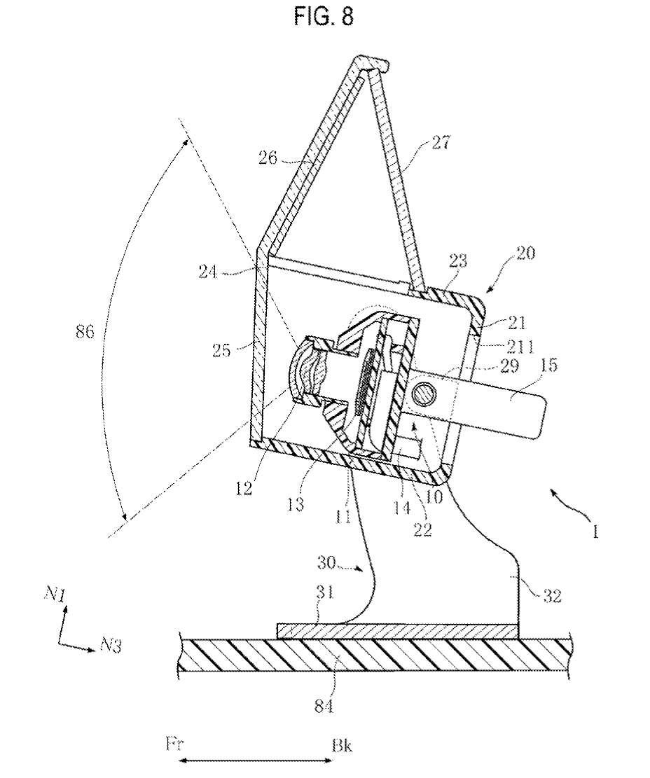

FIGS. 8 through 10 show a vehicle-mounted camera according to a third embodiment of the present disclosure. The vehicle-mounted camera I of the present embodiment differs from the cameras of the above embodiments in that the vehicle-mounted camera 1 is installed on an upper surface of a dashboard 84. In the present embodiment, the installation plate 31 of the bracket 30 is attached to the upper surface of the dashboard 84. The case 20 is installed in a posture in which the direction N1 is slightly inclined with respect to the vertical direction. The front surface of the camera unit 10 faces toward the front side Fr. The mirror 26 is positioned above the light-transmitting window 25.

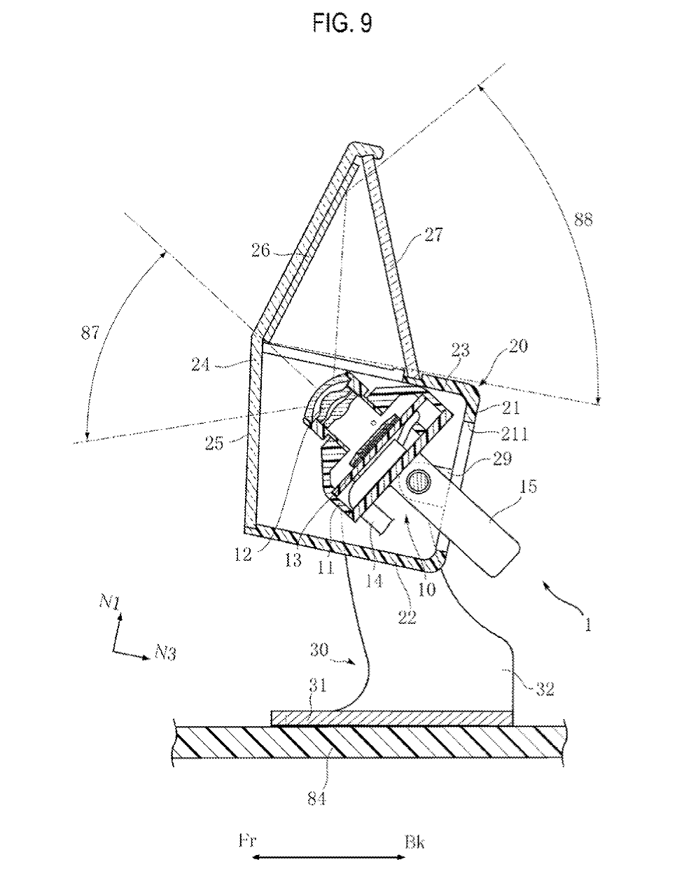

FIG. 8 illustrates the vehicle-mounted camera 1 of the present embodiment assuming a first posture. In this state, the front region of the motor vehicle 81 is captured in the image taken by the camera unit 10. FIG. 9 illustrates the vehicle-mounted camera 1 of the present embodiment assuming a second posture. In this state, the in-vehicle situation and the rear region of the motor vehicle 81 are captured in the upper area of the image taken by the camera unit 10 while the front region of the motor vehicle 81 is captured in the lower area of the image taken by the camera unit 10.

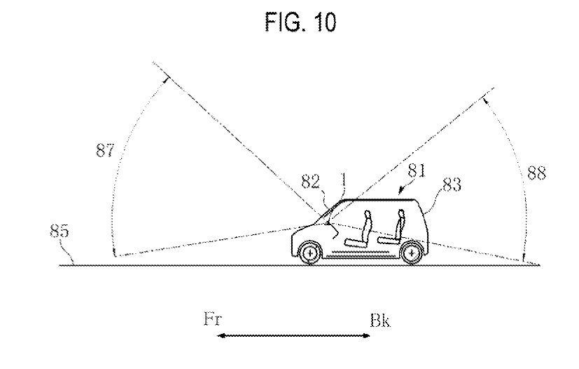

In the present embodiment, it is possible for the camera unit 10 to widely and clearly take an image of a certain region and simultaneously take images of a plurality of different regions. Moreover, as shown in FIG. 10, the angle of view 87 is largely occupied by the windshield 82. A relatively small region is blocked by the dashboard 84. The angle of view 88 covers a region between a front end portion of a roof of the motor vehicle 81 and a lower end portion of a backrest of a seat. Therefore, when the vehicle-mounted camera 1 is in the second posture, the front region, the in-vehicle situation and the rear region can be widely captured in the image taken by the camera unit 10.

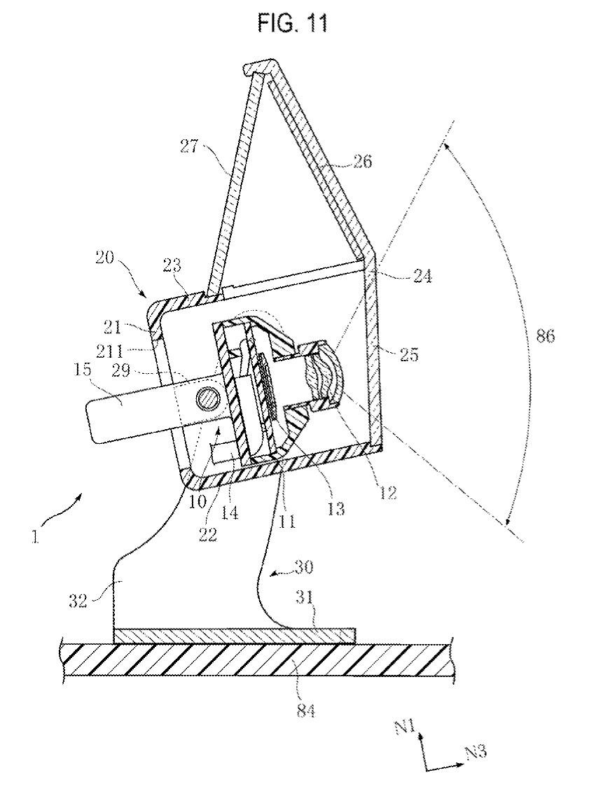

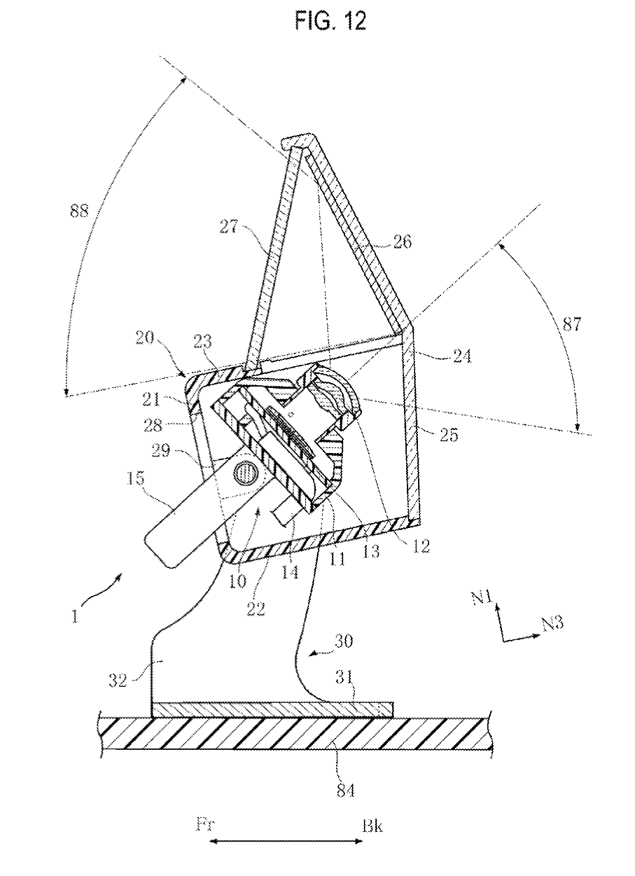

FIGS. 11 through 12 show a vehicle-mounted camera according to a fourth embodiment of the present disclosure. The vehicle-mounted camera 1 of the present embodiment differs from the camera of the third embodiment in that the front surface of the camera unit 10 faces toward the back side Bk. FIG. 11 illustrates the vehicle-mounted camera 1 of the present embodiment assuming a first posture. In this state, the in-vehicle situation and the rear region of the motor vehicle 81 are captured in the image taken by the camera unit 10. FIG. 12 illustrates the vehicle-mounted camera 1 of the present embodiment assuming a second posture. In this state, the front region of the motor vehicle 81 is captured in the upper area of the image taken by the camera unit 10 while the in-vehicle situation and the rear region of the motor vehicle 81 are captured in the lower area of the image taken by the camera unit 10.

In the present embodiment, it is possible for the camera unit 10 to widely and clearly take an image of a certain region and simultaneously take images of a plurality of different regions.

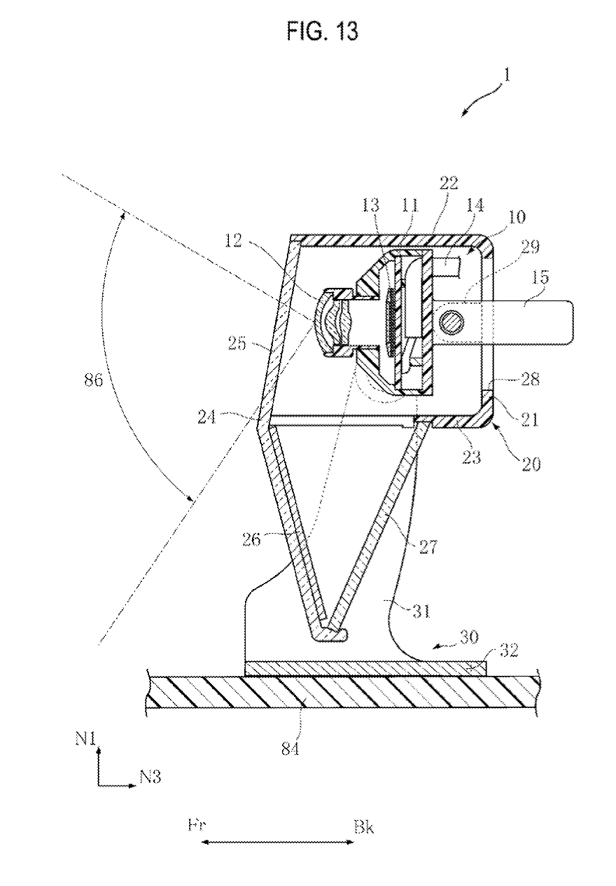

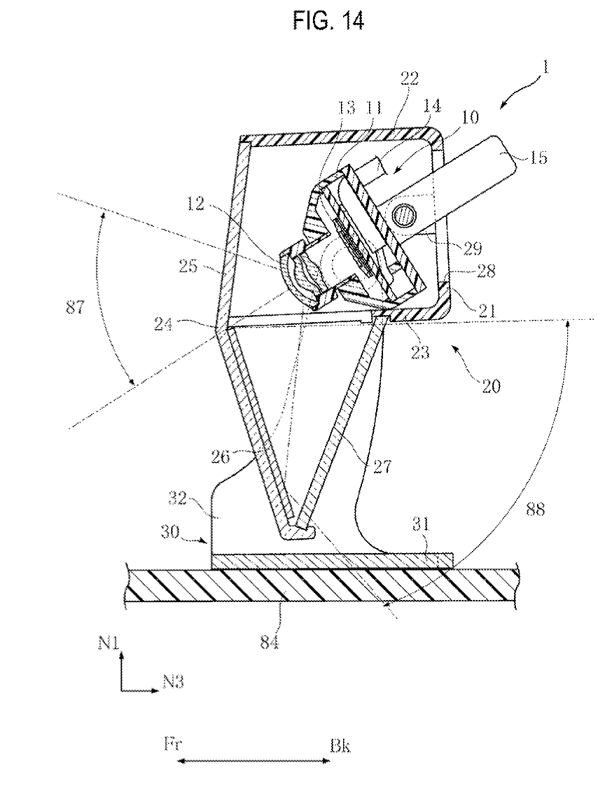

FIGS. 13 through 14 show a vehicle-mounted camera according to a fifth embodiment of the present disclosure. The vehicle-mounted camera 1 of the present embodiment differs from the camera of the third embodiment in that the mirror 26 is arranged below the light-transmitting window 25. FIG. 13 illustrates the vehicle-mounted camera 1 of the present embodiment assuming a first posture. In this state, the front region of the motor vehicle 81 is captured in the image taken by the camera unit 10. FIG. 14 illustrates the vehicle-mounted camera 1 of the present embodiment assuming a second posture. In this state, the front region of the motor vehicle 81 is captured in the upper area of the image taken by the camera unit 10 while the in-vehicle situation and the rear region of the motor vehicle 81 are captured in the lower area of the image taken by the camera unit 10.

In the present embodiment, it is possible for the camera unit 10 to widely and clearly take an image of a certain region and simultaneously take images of a plurality of different regions.

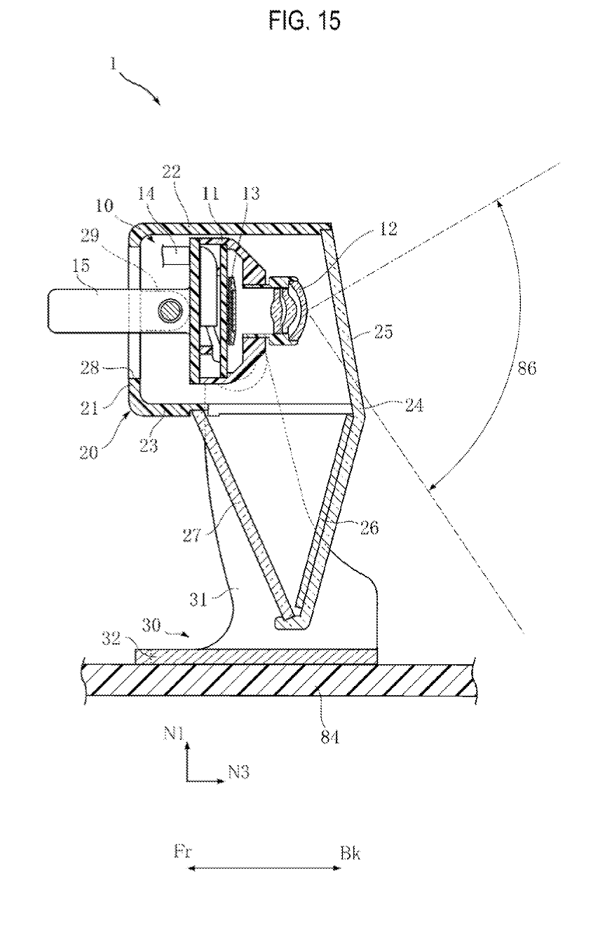

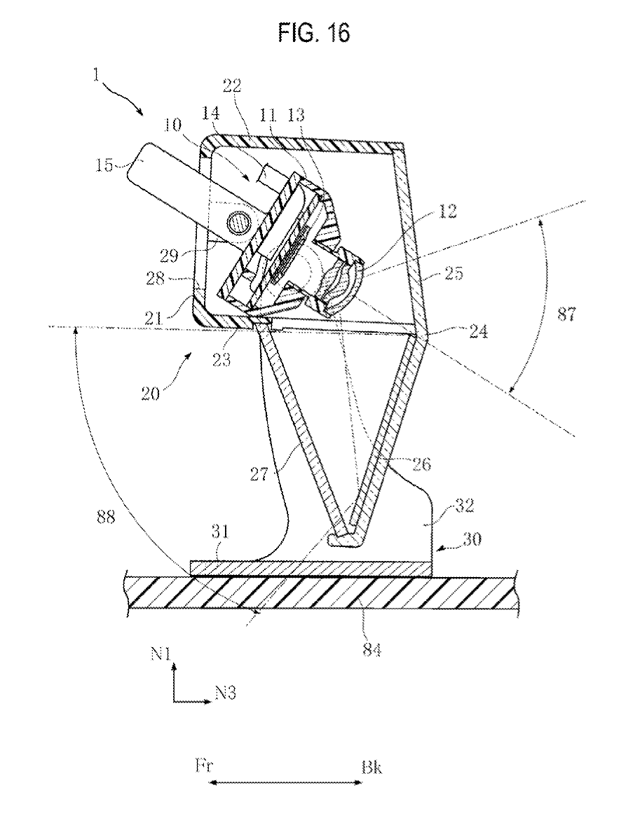

FIGS. 15 through 16 show a vehicle-mounted camera according to a sixth embodiment of the present disclosure. The vehicle-mounted camera 1 of the present embodiment differs from the camera of the fifth embodiment in that the front surface of the camera unit 10 faces toward the back side Bk. FIG. 15 illustrates the vehicle-mounted camera 1 of the present embodiment assuming a first posture. In this state, the in-vehicle situation and the rear region of the motor vehicle 81 are captured in the image taken by the camera unit 10. FIG. 16 illustrates the vehicle-mounted camera 1 of the present embodiment assuming a second posture. In this state, the in-vehicle situation and the rear region of the motor vehicle 81 are captured in the upper area of the image taken by the camera unit 10 while the front region of the motor vehicle 81 are captured in the lower area of the image taken by the camera unit 10.

In the present embodiment, it is possible for the camera unit 10 to widely and clearly take an image of a certain region and simultaneously take images of a plurality of different regions.

The vehicle-mounted cameras according to the present disclosure are not limited to the embodiments described above. Specific configurations of the respective components of the vehicle-mounted cameras according to the present disclosure may be changed according to many different designs as required.

While certain embodiments have been described, these embodiments have been presented by way of example only, and are not intended to limit the scope of the disclosures. Indeed, the novel vehicle-mounted cameras described herein may be embodied in a variety of other forms; furthermore, various omissions, substitutions and changes in the form of the embodiments described herein may be made without departing from the spirit of the disclosures. The accompanying claims and their equivalents are intended to cover such forms or Modifications as would fall within the scope and spirit of the disclosures.

What is claimed is:

1. A vehicle-mounted camera, comprising:
an imaging device having a predetermined imaging range; and
a light-transmitting window and a reflection device adjoining to each other in a first direction, the imaging device configured to selectively assume one of a first posture, in which the light-transmitting window occupies a greater proportion oldie imaging range than the reflection device, and a second posture, in which the reflection device occupies a greater proportion of the imaging range than in the first posture.

2. The camera of claim 1, further comprising:
a case in which the light-transmitting window and the reflection device are arranged, the case configured to rotatably support the imaging device in a second direction perpendicular to the first direction.

3. The camera of claim 2, wherein the case includes a rear plate portion positioned at a rear side of the imaging device and a top plate portion positioned at one side of the imaging device in the first direction.

4. The camera of claim 3, further comprising:
a transparent plate attached to a front end of the top plate portion to face the imaging device,
wherein the reflection device includes a mirror arranged on a first portion of the transparent plate at the other side of the imaging device in the first direction, and the light-transmitting window is formed in a second portion of the transparent plate.

5. The camera of claim 4, wherein at least the second portion of the transparent plate in which the light-transmitting window is formed is applied with an anti-reflection coating.

6. The camera of claim 4, wherein the transparent plate has an elbow formed in a boundary between the light-transmitting window and the mirror.

7. The camera of claim 4, further comprising:
an auxiliary transparent plate attached to an end of the transparent plate at the other side of the imaging device in the first direction, the auxiliary transparent plate configured to extend toward the one side of the imaging device in the first direction and to terminate at the rear side of the imaging device.

8. The camera of claim 3, wherein the rear plate portion has an opening, the imaging device including a rotation lever protruding outward through the opening.

9. The camera of claim 2, wherein the light-transmitting window has an elongated rectangular shape extending in the second direction.

10. The camera of claim 2, wherein the reflection device has an elongated rectangular shape extending in the second direction.

11. The camera of claim 2, further comprising:
a bracket configured to rotatably support the case in the second direction.

12. The camera of claim 11, wherein the bracket includes an installation plate extending in the second direction and a pair of support plates extending from opposite ends in the second direction of the installation plate toward opposite ends in the second direction of the case, the case rotatably connected to the support plates.

13. The camera of claim 11, wherein the bracket is attached to an inner surface of a windshield or a rearview mirror of a motor vehicle, and the light-transmitting window is positioned above the reflection device.

14. The camera of claim 13, wherein the light-transmitting window and the reflection device are positioned in front of the imaging device in a travel direction of the motor vehicle, and
wherein a front region of the motor vehicle is captured by the imaging device in the imaging range through the light-transmitting window, when the imaging device is in the first posture, while the front region of the motor vehicle is captured by the imaging device in the imaging range through the light-transmitting window with at least one of an inside of the motor vehicle and a rear region of the motor vehicle captured in an area of the imaging range occupied by the reflection device, when the imaging device is in the second posture.

15. The camera of claim 13, wherein the light-transmitting window and the reflection device are positioned behind the imaging device in a travel direction of the motor vehicle, and
wherein at least one of an inside of the motor vehicle and a rear region of the motor vehicle is captured by the imaging device in the imaging range through the light-transmitting window, when the imaging device is in the first posture, while at least one of the inside of the motor vehicle and the rear region of the motor vehicle is captured by the imaging device in the imaging range through the light-transmitting window with a front region of the motor vehicle captured in an area of the imaging range occupied by the reflection device, when the imaging device is in the second posture.

16. The camera of claim 11, wherein the bracket is attached to an upper surface of a dashboard of a motor vehicle, and the light-transmitting window is positioned above the reflection device.

17. The camera of claim 16, wherein the light-transmitting window and the reflection device are positioned in front of the imaging device in a travel direction of the motor vehicle, and
wherein a front region of the motor vehicle is captured by the imaging device in the imaging range through the light-transmitting window, when the imaging device is in the first posture, while the front region of the motor vehicle is captured by the imaging device in the imaging range through the light-transmitting window with at least one of an inside of the motor vehicle and a rear region of the motor vehicle captured in an area of the imaging range occupied by the reflection device, when the imaging device is in the second posture.

18. The camera of claim 16, wherein the light-transmitting window and the reflection device are positioned behind the imaging device in a travel direction of the motor vehicle, and
wherein at least one of an inside of the motor vehicle and a rear region of the motor vehicle is captured by the imaging device in the imaging range through the light-transmitting window, when the imaging device is in the first posture, while at least one of the inside of the motor vehicle and the rear region of the motor vehicle is captured by the imaging device in the imagine range through the light-transmitting window with a front region of the motor vehicle captured in an area of the imaging range occupied by the reflection device, when the imaging device is in the second posture.

19. The camera of claim 11, wherein the bracket is attached to an upper surface of a dashboard of a motor vehicle, and the light-transmitting window is positioned below the reflection device.

20. The camera of claim 19, wherein the light-transmitting window and the reflection device are positioned in front of the imaging device in a travel direction of the motor vehicle, and
wherein a front region of the motor vehicle is captured by the imaging device in the imaging range through the light-transmitting window, when the imaging device is in the first posture, while the front region of the motor vehicle is captured by the imaging device in the imaging range through the light-transmitting window with at least one of an inside of the motor vehicle and a rear region of the motor vehicle captured in an area of the imaging range occupied by the reflection device, when the imaging device is in the second posture.

21. The camera of claim 19, wherein the light-transmitting window and the reflection device are positioned behind the imaging device in a travel direction of the motor vehicle, and
wherein at least one of an inside of the motor vehicle and a rear region of the motor vehicle is captured by the imaging device in the imaging range through the light-transmitting window, when the imaging device is in the first posture, while at least one of the inside of the motor vehicle and the rear region of the motor vehicle is captured by the imaging device in the imaging range through the light-transmitting window with a front region of the motor vehicle captured in an area of the imaging range occupied by the reflection device, when the imaging device is in the second posture.
